(19) United States
(12) Patent Application Publication
(10) Pub. No.: US 2025/0294096 A1
(43) Pub. Date: Sep. 18, 2025

(54) INFORMATION PROCESSING APPARATUS, RECEPTION METHOD, AND NON-TRANSITORY RECORDING MEDIUM

(71) Applicant: Hiroaki IKKANZAKA, Saitama (JP)

(72) Inventor: Hiroaki IKKANZAKA, Saitama (JP)

(21) Appl. No.: 19/073,062

(22) Filed: Mar. 7, 2025

(30) Foreign Application Priority Data
Mar. 18, 2024 (JP) 2024-041893

(51) Int. Cl. H04N 1/00

(52) U.S. Cl. CPC H04N 1/00005; H04N 1/00074

(57) ABSTRACT

An information processing apparatus includes circuitry. The circuitry detects an error related to image data received by a facsimile device. The circuitry determines whether to notify a user of error information including the image data in which the error is detected, based on a status of the error in the image data. The circuitry notifies the user of the error information when the circuitry determines to notify the user of the error information.

### CROSS-REFERENCE TO RELATED APPLICATIONS

This patent application is based on and claims priority pursuant to 35 U.S.C. § 119 (a) to Japanese Patent Application No. 2024-041893, filed on Mar. 18, 2024, in the Japan Patent Office, the entire disclosure of which is hereby incorporated by reference herein.

### BACKGROUND

### Technical Field

The present disclosure relates to an information processing apparatus, a reception method, and a non-transitory recording medium.

### Related Art

In a facsimile device, a technique has been proposed for notifying a sender of an abnormality signal indicating an image-quality abnormality when the facsimile device detected the image-quality abnormality such as an error line in facsimile reception of data including image data.

For example, a facsimile device notifies an administrator of information about image data in which an error has been detected, the administrator determines whether to request contact with a sender, and the administrator returns the result determined by the administrator to the facsimile device.

### SUMMARY

The present disclosure described herein provides an information processing apparatus including circuitry. The circuitry detects an error related to image data received by a facsimile device. The circuitry determines whether to notify a user of error information including the image data in which the error is detected, based on a status of the error in the image data. The circuitry notifies the user of the error information when the circuitry determines to notify the user of the error information.

The present disclosure described herein provides a reception method performed by one or more computers. The method includes detecting an error related to image data received by a facsimile device. The method includes determining whether to notify a user of error information including the image data in which the error is detected, based on a status of the error of the image data. The method includes notifying the user of the error information when the determining determines to notify the user of the error information.

The present disclosure described herein provides a non-transitory recording medium storing a plurality of instructions which, when executed by one or more processors, causes the one or more processors to perform a reception method. The reception method includes detecting an error related to image data received by a facsimile device. The reception method includes determining whether to notify a user of error information including the image data in which the error is detected, based on a status of the error of the image data. The reception method includes notifying the user of the error information when the determining determines to notify the user of the error information.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an example of a configuration of a facsimile system;

FIG. 2 is a diagram illustrating an example of a hardware configuration of a facsimile device;

FIG. 3 is a diagram illustrating an example of a hardware configuration of a client personal computer (PC);

FIG. 4 is a block diagram illustrating an example of a functional configuration of a facsimile device;

FIG. 5 is a block diagram illustrating an example of a functional configuration of a client PC;

FIG. 6 is a diagram illustrating an example of an error data table stored by the facsimile device;

FIG. 7 is a diagram illustrating an example of an address book stored by a facsimile device;

FIG. 8 is a diagram illustrating an example of locations of errors and setting values set by an administrator;

FIG. 9 is a diagram illustrating another example of locations of errors and administrator setting values;

FIG. 10 is a diagram illustrating an example of error information transmitted to a client PC by a facsimile device;

FIG. 11 is a block diagram illustrating another example of a functional configuration of a facsimile device;

FIG. 12 is a flowchart illustrating an example of a processing procedure for notifying an administrator by a facsimile device; and

FIG. 13 is a flowchart illustrating an example of a processing procedure for a reply from an administrator by a facsimile device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, descriptions are given of a facsimile device, a reception method, and a non-transitory recording medium according to embodiments of the present disclosure with reference to the drawings. The present disclosure, however, is not limited to the following embodiments, and constituent elements of the following embodiments include elements conceivable by those skilled in the art, substantially the same elements, and elements within so-called equivalent ranges. Furthermore, various omissions, substitutions, changes, and combinations of the constituent elements may be made without departing from the gist of the following embodiments.

### Overall Configuration of System

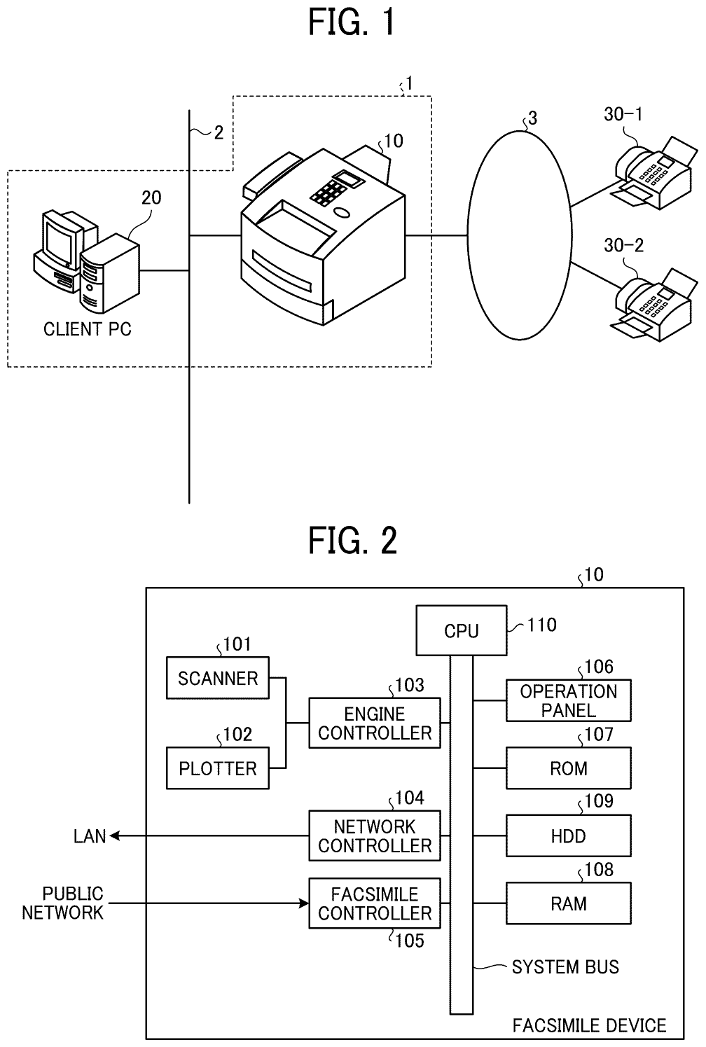

FIG. 1 is a diagram illustrating an example of a configuration of a facsimile system 1. As illustrated in FIG. 1, the facsimile system 1 includes a client PC 20 and a facsimile device 10. The client PC 20 and the facsimile device 10 are connected to each other via an internal network 2 such as a local area network (LAN). In the example of FIG. 1, the number of each of the client PC 20 and the facsimile device 10 is one, but the number of each of the client PC 20 and the facsimile device 10 is not limited to one, and is any selected number.

The facsimile device 10 is connected to, e.g., external facsimile devices 30-1 and 30-2 via an external network 3 such as a public line and the Internet. The client PC 20 is, e.g., a PC owned by an administrator of the facsimile device 10, and manages the facsimile device 10 by exchanging various kinds of information with the facsimile device 10.

### Hardware Configuration of Facsimile Device

FIG. 2 is a diagram illustrating an example of a hardware configuration of the facsimile device 10. As illustrated in FIG. 2, the facsimile device 10 includes a scanner 101, a plotter 102, an engine controller 103, a network controller 104, a facsimile controller 105, an operation panel 106, a read-only memory (ROM) 107, a random-access memory (RAM) 108, a hard disk drive (HDD) 109, and a central processing unit (CPU) 110.

The scanner 101 electronically reads a document placed on a document table to generate an image. The plotter 102 prints out an image. The engine controller 103 controls the scanner 101 to cause the scanner 101 to read a document, and controls the plotter 102 to cause the plotter 102 to print out an image. The network controller 104 such as a network interface card (NIC) controls communication via the internal network 2 to communicate with client PC 20. The facsimile controller 105 controls communication via the external network 3 such as a telephone line to communicate with, e.g., external facsimile devices 30-1 and 30-2.

The operation panel 106 includes a liquid crystal display (LCD) that displays a screen, a light emitting diode (LED) that indicates a status, a buzzer, hard keys, and a touch panel, and displays various kinds of information on the LCD and receives input of various kinds of information from the hard keys and the touch panel.

The ROM 107 stores, e.g., a program executed in the CPU 110. The RAM 108 is used for a working area of the CPU 110. The HDD 109 is a storage device that stores various types of information used by the CPU 110. The CPU 110 executes a program stored in the ROM 107 on the RAM 108 to control, e.g., the engine controller 103, the network controller 104, the facsimile controller 105, and the operation panel 106 connected via a system bus.

### Hardware Configuration of Client PC

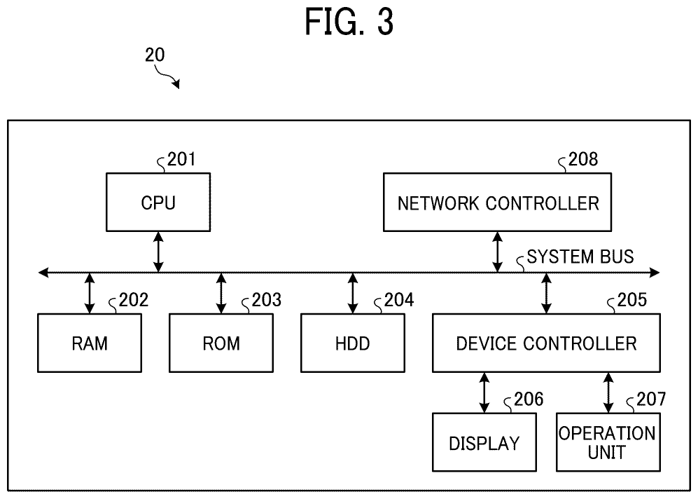

FIG. 3 is a diagram illustrating an example of a hardware configuration of the client PC 20. As illustrated in FIG. 3, the client PC 20 includes a CPU 201, a RAM 202, a ROM 203, an HDD 204, a device controller 205, and a network controller 208, which are connected to each other via the system bus. The device controller 205 is connected to a display 206 and an operation unit 207.

The CPU 201 is a computing means and controls the overall operation of the client PC 20. The RAM 202 is a volatile memory capable of reading and writing information at high speed and is used as a work area when the CPU 201 processes information. The ROM 203 is a read-only nonvolatile memory that stores programs such as firmware.

The HDD 204 is a non-volatile memory capable of reading and writing information, and stores, e.g., an operating system (OS), various control programs, and application programs. The HDD 204 stores, e.g., files and data necessary for implementing various functions of the client PC 20.

The device controller 205 connects each of the display 206 and the operation unit 207 to the system bus. The display 206 is a visual user interface that displays various kinds of information, and is configured by, e.g., an LCD. The operation unit 207 is a user interface such as a keyboard and a mouse that enables a user such as an administrator of the facsimile device 10 to input various kinds of information to the client PC 20.

The network controller 208 connects the client PC 20 to the internal network 2.

### Functional Configuration of Facsimile Device

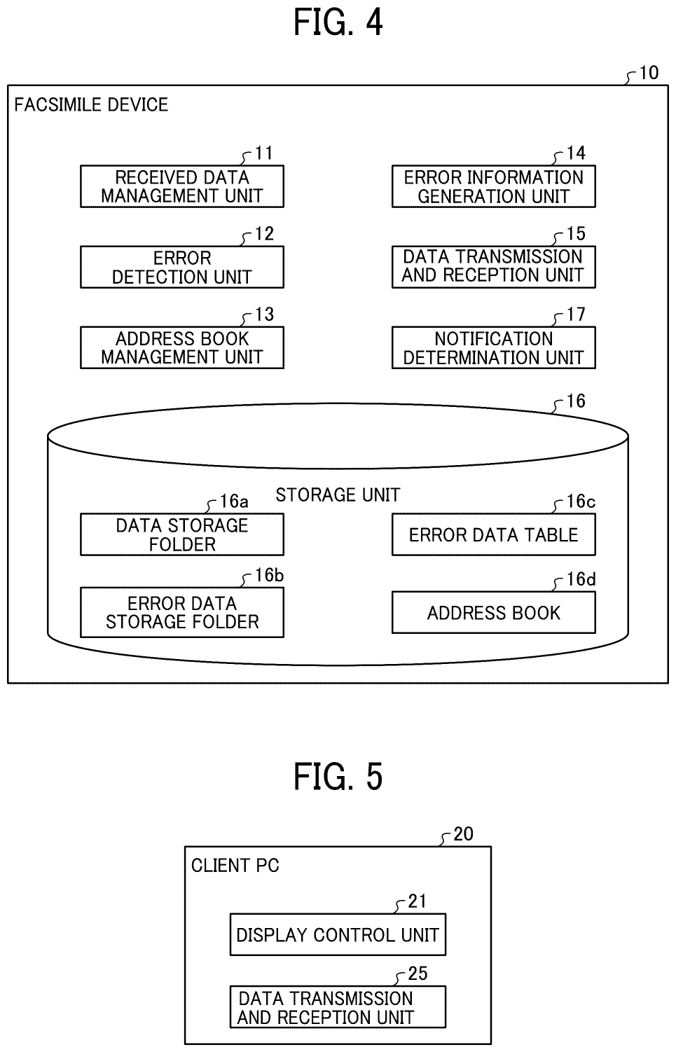

FIG. 4 is a block diagram illustrating an example of a functional configuration of the facsimile device 10. As illustrated in FIG. 4, the facsimile device 10 includes a received data management unit 11, an error detection unit 12, an address book management unit 13, an error information generation unit 14, a data transmission and reception unit 15, a storage unit 16, and a notification determination unit 17.

The received data management unit 11 manages received data received by the facsimile device 10. The received data management unit 11 mainly stores the received data in a data storage folder 16a in the storage unit 16. The received data management unit 11 stores, among the received data, the received data including image data (error data) in which an error is detected by the error detection unit 12 in an error data storage folder 16b in the storage unit 16. The received data management unit 11 adds the received data including the error data to an error data table 16c in the storage unit 16. The received data management unit 11 performs data management such as setting a predetermined flag to the received data in the error data table 16c and deleting the received data in the error data table 16c. The received data management unit 11 is implemented by, e.g., a program that operates in the CPU 110.

The error detection unit 12 is an example of a detection unit that detects an abnormality such as an error line that has occurred in image data included in the received data. The error line occurs in an image when, e.g., an error occurs during reception of image data. The error detection unit 12 is implemented by, e.g., a program that operates in the CPU 110.

The address book management unit 13 manages an address book 16d in the storage unit 16. When an error is detected by the error detection unit 12, the address book management unit 13 determines whether sender information included in the received information including the image data is registered in the address book 16d. When the sender information is registered in the address book 16d, the address book management unit 13 determines whether the email address corresponding to the sender information is registered in the address book 16d. The address book management unit 13 is implemented by, e.g., a program that operates in the CPU 110.

When the error detection unit 12 detects an error in the image data and the notification determination unit 17 determines to notify the administrator of the error, the error information generation unit 14 generates a notification (error information) to the administrator to which the error data is attached. When the email address of the sender is registered in the address book 16d, the error information generation unit 14 also attaches a contact address including the email address to the error information. The error information generation unit 14 is implemented by, e.g., a program that operates in the CPU 110.

The data transmission and reception unit 15 receives data from the external facsimile device 30-1 and 30-2. The received data may include image data. The data transmission and reception unit 15 transmits the error information generated by the error information generation unit 14 to the client PC 20. The data transmission and reception unit 15 receives, from the client PC 20, a reply by the administrator to the error information generated by the error information generation unit 14. The data transmission and reception unit 15 transmits an email that requests retransmission of the image data in which the error is detected to the email address of the sender. The data transmission and reception unit 15 is implemented by, e.g., a program operating in the CPU 110, the network controller 104, and the facsimile controller 105.

The storage unit 16 stores, e.g., various control programs, application programs, and files and data necessary for implementing various functions of the facsimile device 10. For example, the storage unit 16 stores the data storage folder 16a, the error data storage folder 16b, the error data table 16c, and the address book 16d. The data storage folder 16a stores the received data that has been determined to have been received normally without an error being detected. The error data storage folder 16b stores received data including error data. The error data table 16c includes various kinds of information related to the received data including the error data. The address book 16d includes information such as facsimile numbers and email addresses of known senders.

The storage unit 16 is implemented by, e.g., the ROM 107, the RAM 108, and the HDD 109 described above.

The notification determination unit 17 determines whether to notify the administrator of an image in which an error has been detected by the error detection unit 12, as will be described later.

### Functional Configuration of Client PC

FIG. 5 is a block diagram illustrating an example of a functional configuration of the client PC 20. As illustrated in FIG. 5, the client PC 20 includes a display control unit 21 and a data transmission and reception unit 25.

The display control unit 21 controls the display 206 to display various information such as a notification transmitted from the facsimile device 10 on the display 206. The display control unit 21 is implemented by, e.g., a program operating in the CPU 110 and the device controller 205.

The data transmission and reception unit 25 exchanges various kinds of information with the data transmission and reception unit 15 of the facsimile device 10. The data transmission and reception unit 25 is implemented by, e.g., a program operating in the CPU 110 and the network controller 208.

### Functional Details of Facsimile Device

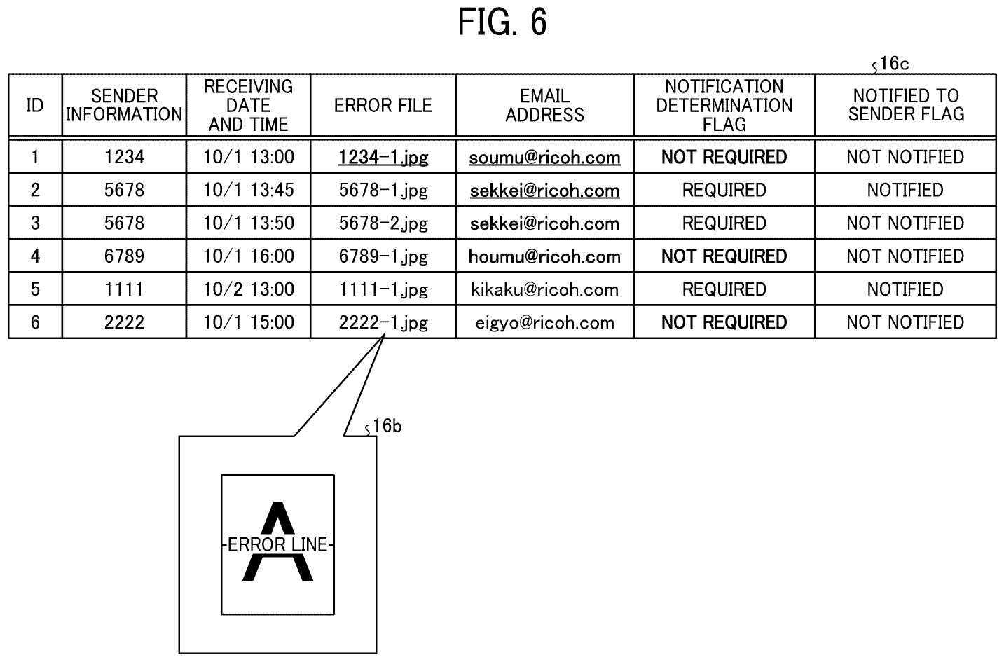

Referring to FIGS. 6 to 9, a description in more detail is given below of the functions of the facsimile device 10. FIG. 6 is a diagram illustrating an example of the error data table 16c stored by the facsimile device 10.

When the data transmission and reception unit 15 of the facsimile device 10 receives data from, e.g., any of the external facsimile devices 30-1 and 30-2, the error detection unit 12 checks whether an error has occurred in the image data included in the received data.

When the error detection unit 12 detects an error, the received data management unit 11 stores the received data including the image data in which the error has occurred in the error data storage folder 16b and adds the received data to the error data table 16c.

As illustrated in FIG. 6, the error data table 16c includes, e.g., information of sender information, a reception date and time, an error file, an email address of a sender, a notification determination flag, and a notified to sender flag.

The error file in the information included in the error data table 16c is the error data stored in the error data storage folder 16b, and is associated with the image data corresponding to the received file.

Each flag in the information included in the error data table 16c is switched to “not notified” or “notified” by the received data management unit 11. Details of each flag will be described later.

The email address in the information included in the error data table 16c is information given by the address book management unit 13. In detail, the address book management unit 13 compares the sender information included in the received data with the address book 16d in the storage unit 16. If the email address corresponding to the sender information is registered in the address book 16d, the address book management unit 13 adds the email address to the corresponding received data in the error data table 16c.

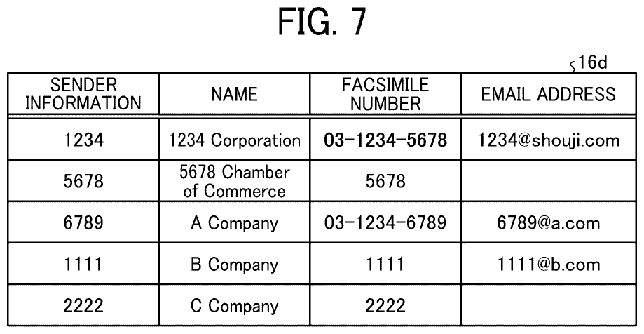

FIG. 7 is a diagram illustrating an example of the address book 16d stored in the facsimile device 10. As illustrated in FIG. 7, the address book 16d includes information about known senders. In detail, the address book 16d includes data in which the name of a sender, a facsimile number, and an email address are associated with sender information that may be included in the received data. However, some senders are not registered because, e.g., the email addresses of some senders are unknown.

When the error detection unit 12 detects an error, the notification determination unit 17 determines whether to notify the administrator of the received data including the error data (whether to notify the administrator) based on a predetermined determination condition. The predetermined determination condition may be that, e.g., (1) the error status of the error data matches the setting value set by the administrator, (2) the error status of all error data is set to be notified, or (3) the error status of the error data is similar to the error status of the error data for which the administrator has requested retransmission (retransmitted error status). The notification determination unit 17 determines to notify the administrator of the received data when the predetermined determination condition is satisfied.

Examples of the “error status” in the determination condition (1) and (3) described above include the location of the error, the number of the errors, and the size of the character at the location of the error. The administrator sets the setting value of the determination condition (1) or sets to use the determination condition (2) by using, e.g., the touch panel of the operation panel 106 of the facsimile device 10. The setting values, the settings, and the information of the retransmitted error status of the determination condition (3) are stored in a storage device such as the HDD 109. The notification determination unit 17 reads the information from the storage device and determines whether the notification to the administrator is to be done. The administrator may select which of the determination conditions (1), (2), and (3) is to be used by the notification determination unit 17 to make the determination by using, e.g., the touch panel of the operation panel 106.

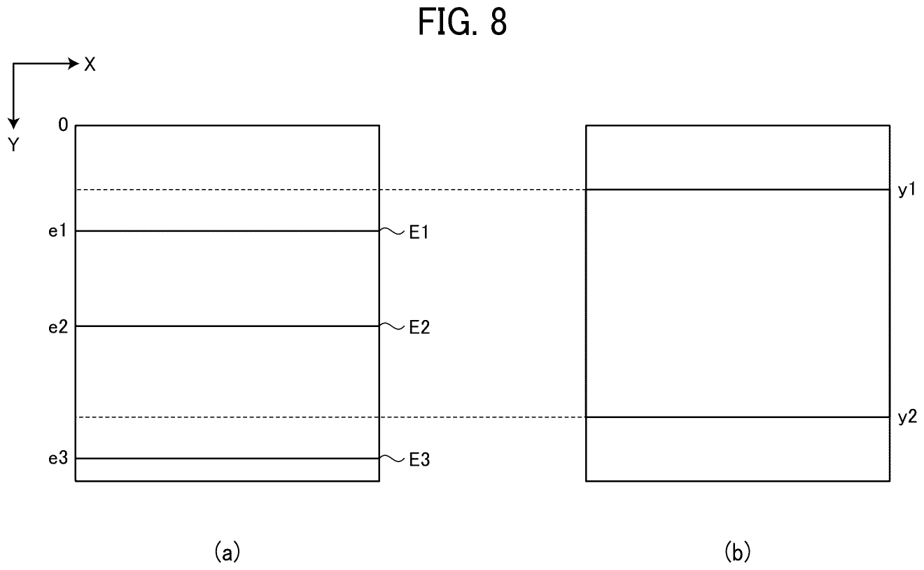

First, an example of using the location of the error in the determination condition (1) will be described. FIG. 8 is a diagram illustrating an example of the locations of errors and setting values set by an administrator. FIG. 8(a) illustrates an example of a case where error lines E1 to E3 are included in Y coordinates e1 to e3 of the image data included in the received data. FIG. 8(b) illustrates an example of setting values for error location set by the administrator. In this example, the administrator is notified when an error line is included in the range from the Y coordinate y1 to the Y coordinate y2 of the image data included in the received data.

In this example, when the image data including the error line E1 or E2 is received, the notification determination unit 17 determines to notify the administrator of the received data because the Y coordinates e1 and e2 are included in the range set from the Y coordinate y1 to the Y coordinate y2. When the image data including only the error line E3 is received, the notification determination unit 17 determines not to notify the administrator of the received data because the Y coordinate e3 is not included in the range set from the Y coordinate y1 to the Y coordinate y2.

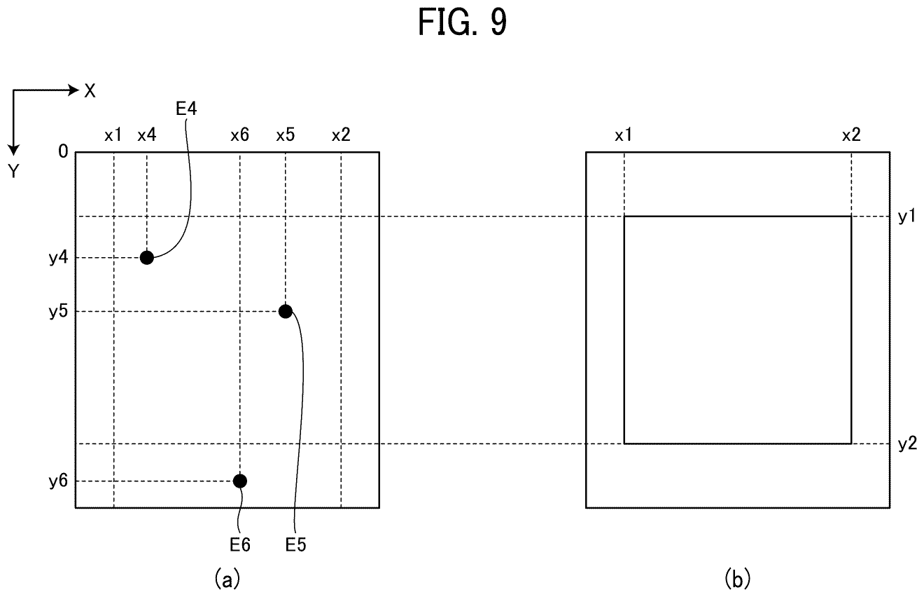

FIG. 9 is a diagram illustrating another example of the locations of errors and setting values set by the administrator. FIG. 9(a) illustrates an example of a case where dot-like errors E4 to E6 are included in the coordinates (x4, y4) to (x6, y6) of the image data included in the received data. FIG. 9(b) illustrates an example of setting values for error location set by the administrator. In this example, the administrator is notified when an error is included in a rectangular range defined by coordinates (x1, y1) and coordinates (x2, y2) of the image data included in the received data.

In this example, when image data including an error E4 or E5 is received, the notification determination unit 17 determines to notify the administrator of the received data according to the determination condition (1), because the coordinates (x4, y4) and (x5, y5) are included in the set rectangular range. When the image data including only the error E6 is received, the notification determination unit 17 determines not to notify the administrator of the received data.

An example of using the number of errors in the determination condition (1) will be described below. The number of errors used in the determination condition (1) is counted as three in each of the examples of FIG. 8(a) and FIG. 9(a). If all the errors in FIG. 8(a) and FIG. 9(a) are included, the number of errors is counted as 6. For example, when the number of errors set by the administrator (threshold value) is five, the notification determination unit 17 determines not to notify the administrator of the received data for the errors in FIG. 8(a) and FIG. 9(a) because the number of errors in FIG. 8(a) and FIG. 9(a) is smaller than the threshold value. On the other hand, the number of errors of the image data including all the errors of FIG. 8(a) and FIG. 9(a) is equal to or greater than the threshold value, and when such image data is received, the notification determination unit 17 determines that the received data is to be notified to the administrator.

An example of using the size of the character at the location of the error in the determination condition (1) will be described below. The size of the character at the location of the error used in the determination condition (1) is, for example, the font size of the character when a part of the character is missing due to the error. In a case where a size (font size) of a character set by the administrator is N points, when the font size of the character at the location of the error is equal to or less than N points, the notification determination unit 17 determines to notify the administrator of the received data based on the determination condition (1). On the other hand, if the font size of the character at the location of the error is larger than N points, the character can be identified even if the error has occurred, and therefore the notification determination unit 17 determines that the administrator is not to be notified of the received data.

The determination condition (3) will be described below. In the determination condition (3), the similarity between the error status and the retransmitted error status is determined by calculating the similarity between the error status and the retransmitted error status using, e.g., the location of the error, the number of errors, the size of the character at the location of the error. The notification determination unit 17 determines to notify the administrator of the received data when the similarity is larger than a predetermined threshold value, and determines not to notify the administrator of the received data when the similarity is equal to or smaller than the predetermined threshold value. The predetermined threshold value may be determined in advance by, e.g., an experiment, and may be determined by, e.g., an evaluation experiment when the facsimile device 10 is designed, or may be determined by, e.g., a test for each model or each device in a manufacturing process.

The similarity between the error status and the retransmitted error status is calculated to be a large value if the distance between the received error location and the error location of the error data for which the administrator has requested retransmission is small, for example. The distance of the location of the error may be calculated using the difference between Y coordinates for error lines, or using the distance of dots on an image plane for dot-like errors.

The similarity between the error status and the retransmitted error status is calculated to be a large value, for example, when the number of received errors is equal to or larger than the number of errors in the error data for which the administrator has requested the retransmission. For example, if the size of the character at the location of the received error is equal to or smaller than the size of the character at the location of the error in the error data for which the administrator has requested the retransmission, the error size is calculated to be a large value.

The determination of the similarity between the error status and the retransmitted error status may be performed using an algorithm generated by the learning effect of machine learning. The machine learning is a technique for causing a computer to acquire a human-like learning ability, and is a technique in which the computer autonomously generates an algorithm necessary for identifying data and determining a similarity between data from learning data that is taken in, in advance, and applies the algorithm to new data to perform prediction. Any suitable learning method can be applied in machine learning, such as supervised learning, unsupervised learning, semi-supervised learning, reinforcement learning, deep learning, or a combination of two or more of these methods.

When the notification determination unit 17 determines to notify the administrator of the received data including the error data based on the predetermined condition as described above, the received data management unit 11 adds the corresponding received data to the error data table 16c. The received data management unit 11 sets the notification determination flag of the corresponding received data to “required” and sets the notified to sender flag to “not notified.”

The error information generation unit 14 generates error information, and the data transmission and reception unit 15 transmits the generated error information to the client PC 20.

When the notification determination unit 17 determines that the administrator is not to be notified of the received data including the error data, the received data management unit 11 sets the notification determination flag of the corresponding received data to “not required” and the notified to sender flag to “not notified,” and adds the received data to the error data table 16c. In this case, the error information is not generated and the administrator is not notified.

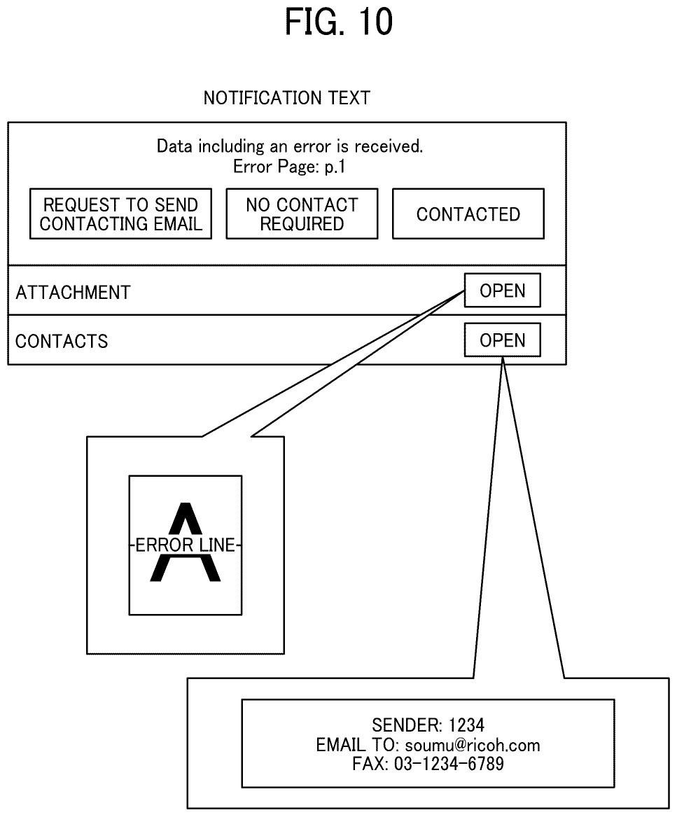

FIG. 10 is a diagram illustrating an example of contents of error information transmitted to the client PC 20 by the facsimile device 10. The error information to the client PC 20 is generated by the error information generation unit 14 based on information in the error data table 16c when the notification determination unit 17 determines to notify the administrator of the error information.

As illustrated in FIG. 10, the error information generation unit 14 refers to the error data table 16c to attach error data to the error information as an attached file. The error information generation unit 14 refers to the error data table 16c. When information on the email address of the sender is registered in the received data corresponding to the image data, the error information generation unit 14 attaches the email address to the error information as a contact address. The error information generation unit 14 also attaches a button to the error information to ask whether to contact the attached email address.

The error information thus generated is sent to the client PC 20 by the data transmission and reception unit 15. The administrator can display the transmitted error information on the display 206 of the client PC 20. The administrator can display the error data on the display 206 by pressing an “open” button in the “attached file” field. The administrator can display the contact information such as the email address of the sender of the error data on the display 206 by pressing the “open” button in the “contacts” field.

The administrator can determine whether to contact the sender based on the information to select any of reply buttons attached to the error information text to reply. When the administrator determines that the contact to the sender is required, the administrator presses a “request to send contacting email” button. When the administrator determines that the contact to the sender is not required, the administrator presses a “no contact required” button. If the administrator has already made, e.g., a telephone call to the sender to request retransmission, the administrator presses the “contacted” button.

When the administrator presses any of the reply buttons, the data transmission and reception unit 15 of the facsimile device 10 receives the reply. When the received reply indicates that administrator has pressed the “request to send contacting mail” button, the data transmission and reception unit 15 transmits an email for requesting retransmission of data to the email address of the sender. Then, the received data management unit 11 changes the notified to sender flag of the corresponding received data in the error data table 16c from “not notified” to “notified.” When the received reply indicates that administrator has pressed the “notified” button, the received data management unit 11 changes the notified to sender flag of the corresponding received data in the error data table 16c from “not notified” to “notified.” When the received reply indicates that administrator has pressed the “request to send contacting email” button, the “notified” button, or the “not required” button, the received data management unit 11 deletes the corresponding received data in the error data table 16c and the corresponding image data in the error data storage folder 16b.

The error information may be displayed on the LCD of the operation panel 106 of the facsimile device 10 or on a display terminal whose operation panel 106 is separated from the facsimile device 10, instead of being sent to the client PC 20. The display terminal separated from the facsimile device 10 includes an LCD and a touch panel similar to the operation panel 106, and has a function similar to the operation panel 106.

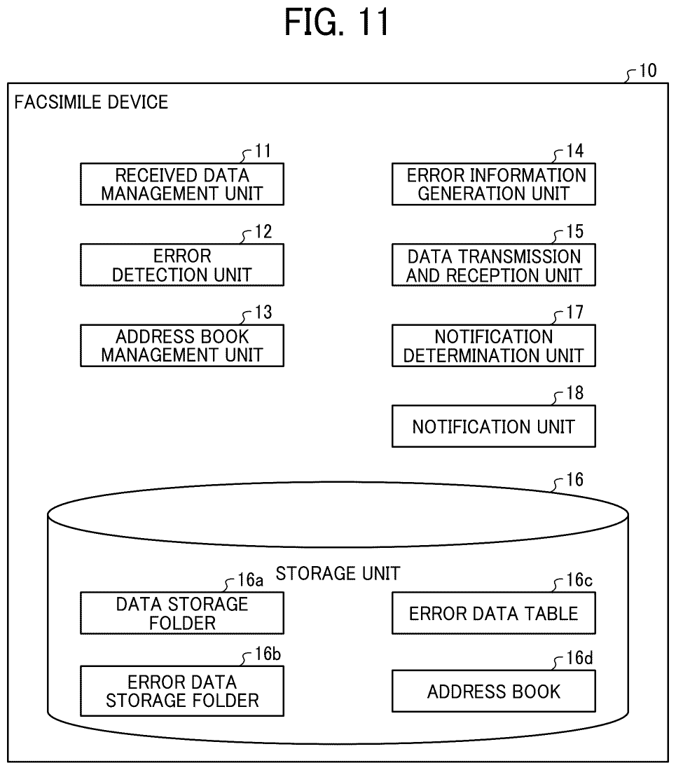

FIG. 11 is a block diagram illustrating another example of the functional configuration of the facsimile device 10. The difference from FIG. 4 is that the facsimile device 10 further includes a notification unit 18, and the notification unit 18 notifies the administrator of error information. The other points are the same as or similar to those described with reference to FIG. 4, and thus the description thereof will be omitted.

The notification unit 18 transmits the error information to the client PC 20 as described above. The notification unit 18 may notify the administrator of the error information by displaying the error information on the LCD of the operation panel 106 or a separate display terminal. In this case, the administrator can check the contents of the error information displayed on the operation panel 106 or the LCD of the display terminal to operate the “open” button or the “request to send contacting email” button in the “attached file” field using the operation panel 106 or the touch panel of the display terminal.

### Reception Processing by Facsimile Device

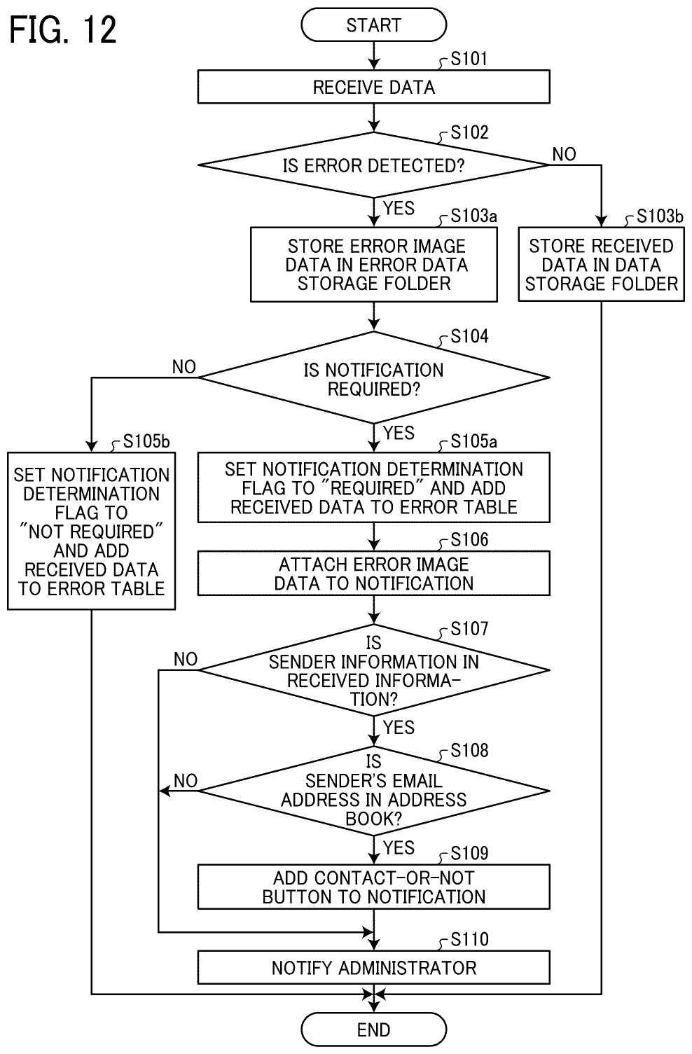

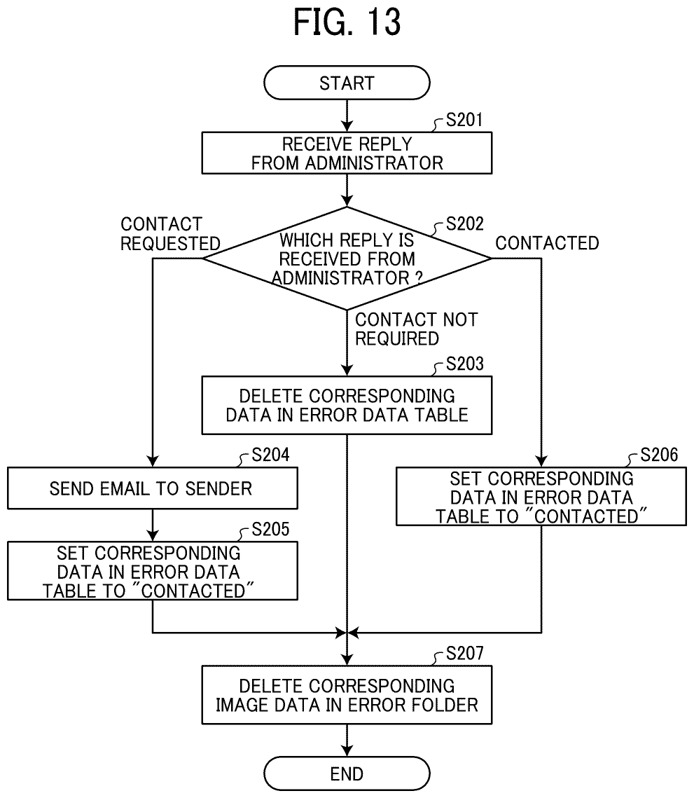

Examples of a reception process performed by the facsimile device 10 according to the embodiment will be described below with reference to FIG. 12 and FIG. 13. FIG. 12 is a flowchart illustrating an example of a processing procedure for notifying the administrator by the facsimile device 10.

As illustrated in FIG. 12, when the data transmission and reception unit 15 of the facsimile device 10 receives data in step S101, in step S102, the error detection unit 12 detects whether an error has occurred in image data included in the received data. If no error is detected (No at step S102), in step S103b, the received data management unit 11 stores the received data in the data storage folder 16a, and the process ends.

If an error is detected (Yes at step S102), in step S103a, the received data management unit 11 stores error data in the error data storage folder 16b.

If the notification determination unit 17 determines that notification is required (Yes at step S104), in step S105a, the received data management unit 11 sets the notification determination flag to “required” and adds the received data including the error data to the error data table 16c. On the other hand, when the notification determination unit 17 determines notification is not required (No at step S104), in step S105b, the received data management unit 11 sets the notification determination flag to “not required,” adds the received data including the error data to the error data table 16c, and the process ends.

After the received data management unit 11 performs the process in step S105a, the error information generation unit 14 generates error information. In other words, in step S106, the error information generation unit 14 attaches the error data (error image data) to the error information. In step S107, the address book management unit 13 determines whether sender information is included in the received data. If the sender information is included in the received data (Yes at step S107), in step S108, the address book management unit 13 refers to the address book 16d to determine whether the email address associated with the sender information is registered.

If the email address is registered in the sender information (Yes at step S108), in step S109, the error information generation unit 14 attaches the email address to the error information and gives a button to ask whether to contact the sender. In step S110, the data transmission and reception unit 15 notifies the administrator of the error information generated in this way. The notification to the administrator may be performed by transmitting the error information to the client PC 20 or by displaying the error information on the LCD of the operation panel 106 or a separate display terminal.

If the sender information is not included in the received data (No at step S107) or if the email address is not registered in the address book management unit 13 (No at step S108), in step S110, the administrator is notified instead of being given with a button to ask whether to contact the sender.

Thus, the facsimile device 10 ends the reception process.

When the notification is sent to the administrator, the administrator selects the reply button to reply to the notification as described above. FIG. 13 is a flowchart illustrating an example of a processing procedure for a reply from the administrator by the facsimile device 10. As illustrated in FIG. 13, when the data transmission and reception unit 15 receives a reply from the administrator in step S201, in step S202, the facsimile device 10 performs processing according to the reply.

When the received reply indicates that the administrator has pressed the “not required” button (contact not required at step S202), in step S203, the received data management unit 11 deletes the corresponding received data in the error data table 10c. In step S207, the received data management unit 11 deletes the image data corresponding to the received data in the error data storage folder 16b, and the process ends.

When the received reply indicates that the administrator has pressed the “request to send contacting email” button (contact requested at S202), in step S204, the data transmission and reception unit 15 transmits an electronic email including error data to the email address of the sender. In step S205, the received data management unit 11 changes the notified to sender flag of the corresponding received data in the error data table 16c from “not notified” to “notified.” In step S207, the received data management unit 11 deletes the image data corresponding to the received data in the error data storage folder 16b, and the process ends.

When the received reply indicates that the administrator has pressed the “contacted” button (contacted at step S202), in step S206, the received data management unit 11 changes the notified to sender flag of the corresponding received data in the error data table 16c from “not contacted” to “contacted.” In step S207, the received data management unit 11 deletes the image data corresponding to the received data in the error data storage folder 16b, and the process ends.

Thus, the facsimile device 10 ends the process for the reply from the administrator.

As described above, according to the embodiment, since error data is notified to the administrator only when a predetermined determination condition is satisfied with respect to image data in which an error is detected, the labor of determination and operation by an administrator is reduced. According to the embodiment, since the error data is notified to the administrator when the status of the error matches the setting value set by the administrator, the administrator can adjust the setting value to adjust the amount of the error data that needs to be determined or operated according to the amount of work by the administrator. Further, according to the embodiment, since notifying all errors may be set, the administrator can receive the notification of all errors to reliably check the errors in a case where there is a margin in the amount of work by the administrator. Further, according to the embodiment, since the error data is notified to the administrator when the status of the error is similar to the status of error data for which the administrator has requested retransmission, the determination of whether notification is required is automatically performed in accordance with the past determination condition set by the administrator, thereby reducing the labor of the determination and operation by the administrator. Further, accumulating the result determined by the administrator can increase the accuracy of the determination of whether notification is required.

### Modification

In the above-described embodiment, when an email address is registered in the sender information of the address book 16d, the sender information is attached to the notification to the administrator. However, this may be modified. Even when the email address is not registered, the sender information may be attached to the notification to the administrator if the corresponding sender information is registered in the address book 16d. Such a configuration can at least prompt the administrator to make a retransmission request to the sender by the administrator himself or herself.

The facsimile device 10 of the above-described embodiment may have at least a facsimile function and may be a device having a facsimile function as a main function, a telephone having a facsimile function, or a multifunction peripheral (MFP) having a facsimile function.

The program executed by a computer in the embodiment is provided by being incorporated in, e.g., the ROM 107 in advance. The program may be provided by being recorded in a computer-readable recording medium such as a compact disc-read only memory (CD-ROM), a flexible disk (FD), a compact disc-recordable (CD-R), or a digital versatile disc (DVD) in a file of an installable format or an executable format.

Furthermore, the program executed in the embodiment may be configured to be stored in a computer connected to a network such as the Internet and provided by being downloaded via the network. The program executed in the embodiment may be provided or distributed via the network such as the Internet.

In the related art, an administrator needs to determine whether to make a contact request to the sender for the image data in which an error has been detected every time to perform an operation, and there is a problem that the administrator's time and effort increase.

The present disclosure provides a facsimile device, a reception method, and a program for reducing the time and effort of the administrator for determination and operation with respect to image data in which an error has been detected.

According to the present disclosure, image data satisfactory for the receiver can be acquired.

Some aspects of the present disclosure are described below.

### Aspect 1

A facsimile device includes a detection unit, a notification determination unit, and a notification unit. The detection unit detects an error related to image data received by the facsimile device. The notification determination unit determines whether to notify an administrator of error information including the image data in which the error has been detected, based on a status of the error of the image data. The notification unit notifies the administrator of the error information when the notification determination unit determines to notify the administrator of the error information.

### Aspect 2

The facsimile device according to Aspect 1 further includes an address book management unit and an error information generation unit. The address book management unit determines whether an email address corresponding to sender information is registered in an address book when the sender information included in received data of the image data in which the error is detected is registered in the address book. The error information generation unit generates the error information when the notification determination unit determines to notify the administrator of the error information. The error information generation unit attaches the email address to the error information when the email address corresponding to the sender information is registered in the address book.

### Aspect 3

In the facsimile device according to Aspect 1 or 2, the status of the error includes at least one of a location of the error, the number of errors, and a size of a character at the location of the error.

### Aspect 4

In the facsimile device according to any one of Aspects 1 to 3, the notification determination unit selects to determine whether to notify the administrator of the error information based on the status of the error or to constantly notify the administrator of the error information.

### Aspect 5

In the facsimile device according to any one of Aspects 1 to 4, the notification determination unit determines whether to notify the administrator of the error information based on whether the status of the error matches a setting value set by the administrator.

### Aspect 6

In the facsimile device according to any one of Aspects 1 to 4, the notification determination unit determines whether to notify the administrator of the error information based on whether the status of the error is similar to an error status of image data for which the administrator has requested retransmission.

### Aspect 7

A reception method performed by a facsimile device includes detecting an error related to image data received by the facsimile device. The reception method includes determining whether to notify an administrator of error information including the image data in which the error is detected, based on a status of the error of the image data. The reception method includes notifying the administrator of the error information when notifying the administrator of the error information is determined in the determining.

### Aspect 8

A program causes a computer to function as a detection unit to detect an error related to image data received by a facsimile device. The program causes the computer to function as a notification determination unit to determine whether to notify an administrator of error information including the image data in which the error is detected, based on a status of the error of the image data. The program causes the computer to function as a notification unit to notify the administrator of the error information when the notification determination unit determines to notify the administrator of the error information.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing apparatus comprising:
circuitry configured to:
detect an error related to image data received by a facsimile device;
determine whether to notify a user of error information including the image data in which the error is detected, based on a status of the error in the image data; and
notify the user of the error information when the circuitry determines to notify the user of the error information.

2. The information processing apparatus according to claim 1,
wherein the circuitry generates the error information when the circuitry determines to notify the user of the error information,
wherein, when sender information indicates a sender of the image data in which the error has been detected, the circuitry determines whether an email address corresponding to the sender information is registered in an address book stored in a memory, and attaches the email address to the error information when the email address corresponding to the sender information is registered in the address book.

3. The information processing apparatus according to claim 1,
wherein the status of the error indicates at least one of a location of the error, the number of the errors, or a size of a character at the location of the error.

4. The information processing apparatus according to claim 1,
wherein the circuitry is configured select to determine whether to notify the user of the error information based on the status of the error or to constantly notify the user of the error information.

5. The information processing apparatus according to claim 1,
wherein the circuitry determines whether to notify the user of the error information based on whether the status of the error matches a setting value set by the user.

6. The information processing apparatus according to claim 1,
wherein the circuitry determines whether to notify the user of the error information based on whether the status of the error is similar to an error status of image data for which the user has requested retransmission.

7. A reception method performed by one or more computers, the method comprising:
detecting an error related to image data received by a facsimile device;
determining whether to notify a user of error information including the image data in which the error is detected, based on a status of the error of the image data; and
notifying the user of the error information when the determining determines to notify the user of the error information.

8. A non-transitory recording medium storing a plurality of instructions which, when executed by one or more processors, causes the one or more processors to perform a reception method, the reception method comprising:
detecting an error related to image data received by a facsimile device;
determining whether to notify a user of error information including the image data in which the error is detected, based on a status of the error of the image data; and
notifying the user of the error information when the determining determines to notify the user of the error information.
